(19) United States
(12) Patent Application Publication
(10) Pub. No.: US 2020/0388825 A1
(43) Pub. Date: Dec. 10, 2020

(54) PRE-CYCLED SILICON ELECTRODE

(71) Applicant: GM GLOBAL TECHNOLOGY OPERATIONS LLC, Detroit, MI (US)

(72) Inventors: Mark W. Verbrugge, Troy, MI (US); Xiaosong Huang, Novi, MI (US); Raghunathan K, Troy, MI (US)

(21) Appl. No.: 16/436,173

(22) Filed: Jun. 10, 2019

(51) Int. Cl. H01M 4/134; H01M 10/0525; H01M 4/38; H01M 4/36; H01M 4/62; H01M 4/04

(52) U.S. Cl. CPC H01M 4/134; H01M 10/0525; H01M 4/386; H01M 2004/027; H01M 4/366; H01M 4/622; H01M 4/0445; H01M 4/382

(57) ABSTRACT

In an embodiment, an electrode comprises a current collector and an active layer located on at least one side of the current collector and in electrical communication with the current collector. The active layer comprises a binder and an expanded silicon; wherein the active layer expands by less than or equal to 10 volume percent when in use. In another embodiment, a method of forming an electrode comprises forming the electrode from a pre-cycled, expanded silicon.

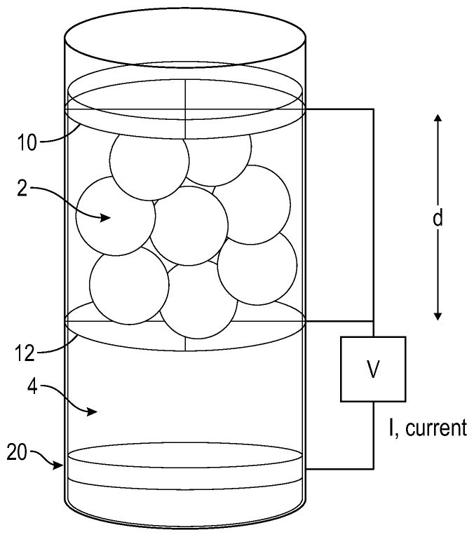

### INTRODUCTION

Current materials for negative electrodes for use in commercial lithium ion batteries generally rely on graphite as the active layer. Unfortunately, the theoretical specific capacity of graphite is only 372 milliampheres hour per gram (mAh/g), which does not meet the development requirements of the new generation of high-capacity lithium ion batteries. In developing new materials for negative electrodes, silicon has been proposed due to its significantly higher theoretical lithium storage capacity of 4,200 mAh/g and a low lithium delithiation voltage platform (about 0.4 volts versus a Li reference electrode). Although some silicon electrodes have been prepared, there are still considerable hurdles to overcome.

Accordingly, it is desirable to provide an improved silicon electrode.

### SUMMARY

In one exemplary embodiment an expanded silicon electrode comprises a current collector and an active layer located on the current collector and in electrical communication with the current collector. The active layer comprises a binder, an expanded silicon, and optionally lithium. The expanded silicon has the formula LiₓSi, where 0≤x≤3.75. The active layer expands by less than or equal to 10 volume percent when in use relative to the initial volume of the active layer prior to use.

In addition to one or more of the features described herein, the expanded silicon has a pore volume of 60 to 90 vol %, or 70 to 80 vol % based on a total volume of the expanded silicon.

In addition to one or more of the features described herein, the expanded silicon has a BET surface area per unit mass of 10 to 600 m²/g, or 150 to 500 m²/g.

In addition to one or more of the features described herein, the active layer comprises 60 to 99 wt %, or 70 to 95 wt % of the expanded silicon based on the total weight of the active layer.

In addition to one or more of the features described herein, the expanded silicon comprises at least one of a carbon coating or an alumina coating.

In addition to one or more of the features described herein, the binder comprises at least one of a fluoropolymer, a rubber, a poly(amic acid), a polyimide, a polyamide, a phenolic resin, a cellulose based binder, poly(acrylic acid), a polyacrylonitrile, an alginate based binder, or an epoxy resin.

In addition to one or more of the features described herein, the active layer further comprises at least one of tin, carbon, manganese, iron, zinc, or aluminum.

In addition to one or more of the features described herein, the electrode is a negative electrode.

In another exemplary embodiment, a battery comprises a positive electrode, an expanded silicon negative electrode, and a separator located in between the positive electrode and the expanded silicon negative electrode. The expanded silicon negative electrode comprises a current collector and an active layer located on at least one side of the current collector and in electrical communication with the current collector. The active layer comprises a binder, an expanded silicon, and optionally lithium, wherein the expanded silicon has the formula LiₓSi, where 0≤x≤3.75. The active layer expands by less than or equal to 10 volume percent when in use relative to the initial volume of the active layer prior to use.

In addition to one or more of the features described herein, the battery is a lithium ion battery.

In yet another exemplary embodiment, a method of forming an active layer for an electrode comprises electrochemically cycling an initial silicon versus lithium from a first voltage to a second voltage at least two times to form an expanded silicon. After the electrochemically cycling, the expanded silicon has the formula LiₓSi, where 0≤x≤3.75. The expanded silicon can be washed with an inert solvent. A mixture comprising the expanded silicon, a binder, and an optional solvent is formed and the active layer is formed from the mixture. The active layer expands by less than or equal to 10 volume percent when in use relative to the initial volume of the active layer prior to use.

In addition to one or more of the features described herein, the electrochemically cycling occurs in an electrochemical cell comprising two working electrode current collectors in parallel, a lithium counter electrode; wherein the two working electrode current collectors are positioned such that they maintain electrical communication with the initial silicon and can increase a relative distance there between during electrochemically cycling to form the expanded silicon.

In addition to one or more of the features described herein, the electrochemical cell further comprises an electrically conductive, inert particle dispersed in the initial silicon.

In addition to one or more of the features described herein, the electrochemically cycling comprises cycling from a high voltage to a low voltage and back to the high voltage two or more times.

In addition to one or more of the features described herein, the electrochemically cycling comprises cycling from the high voltage to the low voltage occurs at a constant current and wherein the electrochemically cycling comprises holding the low voltage for an amount of time to allow the current to drop before cycling back from the low voltage to the high voltage.

In addition to one or more of the features described herein, the cycling comprises a final cycle wherein the final voltage reaches allows for an amount of lithium to remain in the expanded silicon such that 0≤x≤3.75.

In addition to one or more of the features described herein, the initial silicon comprises greater than or equal to 95 wt % of silicon based on the total weight of the initial silicon.

In addition to one or more of the features described herein, the method comprises etching at least one of the initial silicon or the expanded silicon to leach out an impurity.

In addition to one or more of the features described herein, the mixture further comprises at least one of tin, carbon, manganese, iron, zinc, or aluminum.

In addition to one or more of the features described herein, a volume of the expanded silicon is more than 100% of the volume of the initial silicon.

The above features and advantages, and other features and advantages of the disclosure are readily apparent from the following detailed description when taken in connection with the accompanying drawings and claims.

### BRIEF DESCRIPTION OF THE DRAWING

Other features, advantages, and details appear, by way of example only, in the following detailed description, the detailed description referring to the drawing, in which the FIGURE is an electrochemical cell for forming an expanded silicon.

### DETAILED DESCRIPTION

The following description is merely exemplary in nature and is not intended to limit the present disclosure, its application or uses.

Although silicon is an attractive material for use in electrodes due to its high gravimetric energy density, electrodes formed therefrom experience significant volumetric expansion during the initial battery cycling. For example, the silicon layer in electrodes can swell in excess of 300 volume percent (vol %) upon lithiation. The volumetric expansion of the silicon layer undesirably results in cracking of a protective layer deposited thereon, thereby reducing the effectiveness of the protective layer and ultimately of the electrode. It was discovered that the volumetric expansion of silicon electrodes could be prevented/minimized by forming the silicon electrode from a pre-cycled, expanded silicon. In this manner, the expanded silicon in the silicon electrode has already experienced any expansion it otherwise would have experienced in use in a battery. Accordingly, the active layer in the expanded silicon electrode can expand by less than or equal to 10 vol %, or 0 to 10 vol %, or 0 to 5 vol %, or 0 to 1 vol % relative to the initial volume of active layer prior to use in the battery.

The method of forming an active layer for an electrode can include electrochemically cycling an initial silicon versus lithium from a first voltage to form an expanded silicon. A mixture comprising the expanded silicon, a binder, an optional conductive filler, and an optional solvent can be formed and the active layer can then be formed from the mixture. The resulting active layer can expand by less than or equal to 10 volume percent when in use.

Various benefits and advantages are afforded by the present expanded silicon electrode including a reduced probability of cracking of a protective layer located on the expanded silicon and an enhanced electrode integrity. For example, forming an electrode from coated porous silicon particles that are not pre-expanded will result cracking of the coating during the initial cycling of the battery when in use as the silicon particles expand. Furthermore, this method of forming the expanded silicon electrode from expanded silicon particles has advantages over forming a silicon electrode and expanding the silicon in the electrode in that it is difficult to apply a protective coating over the silicon surfaces with a high amount of surface coverage to an already formed layer, as it is difficult to coat the internal surfaces of the layer.

The method of forming the expanded silicon can comprise electrochemically cycling an initial silicon to form the expanded silicon. The initial silicon can comprise 85 to less than 100 wt %, or greater than or equal to 95 wt %, or 99 to 99.99999 wt %, or 99.5 to 99.9 wt % of silicon based on the total weight of the initial silicon. The silicon can be a silicon alloy comprising at least one of tin, carbon, manganese, iron, zinc, or aluminum. The initial silicon can comprise 0 to 5 wt %, or 0.1 to 1 wt % of the alloy material based on the total weight of the initial silicon. The present method has the benefit that the initial silicon can comprise a lower grade silicon as impurities can be easily removed during the electrochemical cycling or in subsequent wash steps.

The initial silicon can comprise at least one of a particulate silicon or a silicon fiber (for example, a nanofiber). A longest dimension of the silicon particles or a diameter of the silicon nanofibers can be less than or equal to 40 micrometers, or 10 nanometers to 10 micrometers, or 0.1 to 30 micrometers. The initial silicon can have a surface area per unit mass of 1 to 100 meters squared per gram (m²/g), or 1 to 80 m²/g, or 1 to 60 m²/g, or 1 to 50 m²/g, or 1 to 30 m²/g, or 1 to 10 m²/g, or 1 to 5 m²/g, or 2 to 4 m²/g determined using Brunauer-Emmett-Teller (BET) theory. The initial silicon can be partially crystalline or fully crystalline.

The initial silicon can also be a coated silicon (for example, carbon coated silicon). The coated silicon can comprise less than or equal to 20 wt %, or 0 to 10 wt %, or 0.1 to 5 wt %, or 0.5 to 1 wt % of coating materials based on the total weight of the coated silicon.

The initial silicon and an electrolyte can be added to an electrochemical cell. The FIGURE is an embodiment of an electrochemical cell that illustrates that the silicon particles 2 can be located between two parallel, working electrode current collectors 10 and 12 in electrical communication. At least the working electrode current collector 12 located in between a counter electrode 20 and the initial silicon 2 can be porous, having a mesh size small enough to prevent the initial silicon from passing there through, but large enough to allow the flow of the electrolyte solution. The working electrode current collector 10 can be porous or non-porous. Each negative electrode independently can have a mesh size of 0.1 micrometer to 1 millimeter depending on the particle size of the initial silicon. The working electrode current collectors 10 and 12 can be configured to apply a force on the silicon particles 2 such that the silicon particles 2 maintain contact with one another to allow for the charge to flow through the particles. Additionally, the working electrode current collectors 10 and 12 can be configured to allow for an increase in their separation distance, d, to accommodate the expansion of the silicon particles 2 as the expanded silicon is formed.

Although not illustrated, the electrochemical cell, for example, as illustrated the FIGURE can comprise a current collector that can receive and transport electrons from the external circuit to the silicon particles 2. The current collector can comprise at least one of copper, stainless steel, nickel, titanium, platinum, gold, silver, aluminum, magnesium, or vanadium. While aluminum and magnesium can be used, these materials may not be selected in order to avoid side reactions during the lithiation of the silicon particles 2.

The electrochemical cell can comprise a separator, not shown, that can prevent physical contact between two or more of the electrodes. The separator can comprise a polyolefin (for example, at least one of polyethylene or polypropylene). The separator can comprise at least one of poly(vinylidene fluoride) (PVDF), a polyamide, a polyurethane, a polycarbonate, a polyester (for example, polyethylene terephthalate (PET), polyethylene naphthenate, or polybutylene terephthalate), a polyetheretherketone (PEEK), a polyethersulfone (PES), a polyimide (PI), a polyether, a polyoxymethylene, a polybutene, an acrylonitrile-butadiene styrene copolymer (ABS), a polystyrene, a polymethylmethacrylate (PMMA), a polyvinyl chloride (PVC), a polysiloxane (for example, polydimethylsiloxane (PDMS)), a polybenzimidazole (PBI), a polybenzoxazole (PBO), a polyphenylene, a poly(arylene ether ketone), a polyperfluorocyclobutane, a polytetrafluoroethylene (PTFE), a poly(vinylidene chloride), a polyvinylfluoride, a liquid crystalline polymer, a poly(p-hydroxybenzoic acid), a polyaramide, or a polyphenylene oxide. The separator can comprise a ceramic material, for example, at least one of Al₂O₃, Si₃N₄, or SiC.

An electrically conductive, inert particle can be dispersed in the initial silicon. The electrically conductive, inert particle can comprise at least one of carbon, copper, nickel, or stainless steel. The carbon can comprise at least one of graphite, graphene, carbon fibers, carbon nanotubes, carbon black, or hard carbon. Hard carbon can be a carbon that does not convert into graphite even with heating in excess of 2,800 degrees Celsius (° C.).

The working electrode current collectors 10 and 12 can each independently comprise at least one of copper or nickel or stainless steel. The counter electrode 20 can comprise a lithium counter electrode, for example, located on a conductive film (for example, a copper film). It is noted that while the FIGURE illustrates a lithium counter electrode 20, any lithium source could be used.

The electrochemical cell, for example, as illustrated in the FIGURE comprises an electrolyte 4. The electrolyte 4 can be added to neutralize the positive and negative charges that form around the electrodes. The electrolyte 4 can comprise a lithium compound in an electrolyte solvent. The lithium compound can comprise at least one of lithium hexafluorophosphate (LiPF₆), lithium tetrafluoroborate (LiBF₄), lithium perchlorate (LiClO₄), lithium bis(oxalate)borate (LiBOB), LiAlCl₄, LiI, LiBr, LiNO₃, LiB(C₂O₄), LiBF₂(C₂O₄) (LiODFB), LiPF₄(C₂O₄) (LiFOP), LiSCN, LiB(C₆H₅)₄, LiAsF₆, LiCF₃SO₃, LiN(FSO₂)₂ (LiFSI), LiN(CF₃SO₂)₂, or lithium bis(trifluoromethanesulfonyl) imide (LiTFSI).

The electrolyte can comprise at least one of 1,3-dioxolane, tetrahydrofuran, 2-methyltetrahydrofuran, 1,2-dimethoxyethane, 1-2-diethoxyethane, ethoxymethoxyethane, tetraethylene glycol dimethyl ether (TEGDME), polyethylene glycol dimethyl ether (PEGDME), ethylene carbonate, diethyl carbonate, dimethyl carbonate, propylene carbonate, or fluoroethylene carbonate). The electrolyte 4 can be a liquid or can be a gel. The concentration of the lithium compound in the electrolyte 4 can be less than or equal to 2 moles per liter.

The voltage across the electrochemical cell, for example, as illustrated in the FIGURE can be cycled from a high voltage to a low voltage and back to the high voltage versus lithium (for example, a lithium reference electrode). The electrochemical cell can comprise a reference electrode that can be used to monitor the amount of current being applied to the cell. As the voltage cycles from the high voltage to the low voltage, lithium ions from the counter electrode 20 traverse through the electrolyte 4, through the working electrode current collector 12 and to the silicon particles 2 causing them to expand. This reaction can be described by Si+xLi⁺+xe⁻→LiₓSi, where x can be 0≤x≤3.75, or 0≤x≤3.75, or 0.5≤x≤1.5. As the voltage cycles from the low voltage to the high voltage, relative to a Li reference electrode, the lithium ions are removed from the silicon particles 2 and the expanded silicon particles remain. While some contraction is observed after the first cycle, after about 2 cycles, the expanded silicon particles can maintain a final volume of their maximum expanded form.

The cycling can be repeated 2 or more times, for example, 2 to 50 times, or 2 to 3 times, or 3 to 5 times until the final volume is reached and the volume expansion of the expanded silicon has completed. In other words, after a final volume has been reached, further cycling of the expanded volume will result in a volume change of less than or equal to 10 volume percent, or 0 to 1 volume percent when considering the volume before and after the further cycling. The cycling can occur at a constant current density corresponding to a C/20 to 1C, where the 1C rate corresponds to the current density that fills silicon devoid of lithium to being fully lithiated in 1 hour. A preferred rate would be C/10. Variable current schedules can also be used.

The cycling can occur via controlled voltage conditions at a constant current. For example, the voltage can be cycled from the high voltage to the low voltage and back while maintaining a constant current.

The cycling can occur via controlled current, controlled voltage (CCCV) conditions. For example, the voltage can be cycled from the high voltage to the low voltage at a constant current. Once the low voltage is obtained, the voltage can be held constant and the current can be dropped to a first current value while maintaining a constant current. After the first current value is obtained, the voltage can be increased from the low voltage to the high voltage at a constant current. Once the high voltage is obtained, the voltage can be held constant and the current can be dropped to a second current value while maintaining a constant current.

The high voltage can be 0.4 to 5 volts, or 0.5 to 5 volts, or 1 to 3 volts, or 0.5 to 1 volt versus a lithium reference. The low voltage can be 5 to 190 millivolts (mV), 5 to 100 mV, or 40 to 60 mV versus a lithium reference. The relative voltages can be selected such that the silicon has the formula LiₓSi, where 2≤x≤3.75. By incorporating this amount of lithium into the silicon during the cycling can help ensure that the silicon is fully expanded. The cycling from the high voltage to the low voltage and from the low voltage back to the high voltage can each independently take 5 to 100 hours, 5 to 50 hours, or 10 to 20 hours. For example, the cycling can be C/2 to C/50, or C/10 to C/50. Once a target voltage (for example, the low voltage or the high voltage) is reached, the voltage can be held (a potential hold) for a hold time before cycling back up to the high voltage. The hold time can be determined by the amount of time it takes for the current to fall below a target value, for example, the C/50 rate. For example, the time for holding the voltage can be determined by measuring the initial current when the low voltage is reached and then stopping the voltage application when the current is 1/50^{th} of the initially measured current.

During the last cycle, a final voltage increase can be such that an amount of lithium remains in the expanded silicon. The presence of some lithium in the active layer can be sufficient to balance a first cycle inefficiency when used in a battery. For example, a final voltage can be less than 1 volt versus a lithium reference, for example, 0.5 to 0.9 volts. The amount of lithium in the expanded silicon can be x in LiₓSi, where 0≤x≤3.75, or 0≤x≤3.75, or 0.5≤x≤1.5, with x=1 being a preferred amount of lithium.

The electrochemical cycling can expand the volume of the initial silicon by greater than or equal to 100%, or greater than or equal to 250%, or 250 to 350% thereby forming the expanded silicon. The expanded silicon can have a pore volume of 40 to 90 vol %, or 70 to 80 vol %, or 50 to 75 vol % based on a total volume of the expanded silicon. Porosity can be determined by measuring the thickness change before and after the cycling and assuming the amount of material is the same. The expanded silicon can have a BET surface area per unit mass of 10 to 600 m²/g, or 150 to 500 m²/g determined using BET theory.

After the electrochemical cycling, the expanded silicon can be washed with a wash solvent. The wash solvent can be inert such that the wash solvent does not remove the remaining lithium in the expanded silicon. The wash solvent can comprise at least one of N-methyl-pyrrolidone (NMP), acetone, acetonitrile, diethyl ether, gamma butyrolactone, isopropanol, dimethyl carbonate, ethyl carbonate, dimethoxyethane, ethylene carbonate, propylene carbonate, ethanol, or methanol.

An impurity (for example, iron) can be leached out of the silicon before or after the electrochemical cycling. The leaching can comprise introducing the silicon (for example, the initial silicon or the expanded silicon to a leachant). The leachant can comprise an acid or a hydroxide.

The expanded silicon can be coated, for example, with at least one of a carbon layer or an alumina layer prior to forming the active layer. The expanded silicon can be coated such that both the external surfaces of the particles and the internal surfaces of the pores are coated. Since the silicon particles have already been expanded to a final volume, the coating can remain intact during use in a battery operation.

The expanded silicon can be coated using a gaseous carbon source, a liquid carbon source, or a solid carbon source. The gaseous carbon source can comprise at least one of acetylene, methane, ethane, ethylene, propylene, or carbon monoxide. The liquid carbon source can comprise at least one of benzene, toluene, xylene, ethanol, n-hexane, or cyclohexane. The solid carbon source can comprise at least one of poly(vinyl chloride), poly(vinylidene fluoride), polyacrylonitrile, poly(vinyl alcohol), polystyrene, a phenolic resin, an epoxy resin, coal tar pitch, petroleum pitch, sucrose, or glucose.

The carbon coating can be deposited by depositing a methane layer on the expanded silicon and pyrolyzing the methane to form a carbon coating. The pyrolyzing can occur for 0.5 to 2 hours. The pyrolyzing can occur in a reducing atmosphere, for example, in an inert atmosphere comprising at least one of argon, nitrogen, or helium.

The expanded silicon can be coated via atomic layer deposition to form, for example, an alumina coating.

The expanded silicon can comprise 2 to 70 wt %, or 10 to 50 wt % of a coating based on the total weight of the expanded silicon. The coating can have a thickness of 2 to 100 nanometers.

In accordance with an exemplary embodiment, an active layer for an electrode can comprise the expanded silicon. The active layer can be prepared by forming a mixture comprising the expanded silicon, a binder, an optional electronically conductive additive, and an optional solvent. The active layer can then be formed from the mixture.

The active layer can be formed by at least one of gap extruding, slot die extruding, die slurry coating, or blade casting. The active layer can then be calendered. The active layer can be formed by depositing the mixture to a substrate (for example, a polymer sheet or a metal foil) and spreading the mixture on the substrate using a flat surface (for example, a blade) that is controlled to be a certain distance (gap) above the substrate. The thickness of the spread mixture can be controlled by controlling the height of the gap between the flat surface and the substrate. The mixture can then be dried to remove any solvent and to form the active layer. The active layer can be calendered. The mechanical properties of the expanded silicon can be sufficient to withstand the calendering without significant crushing.

A thickness of the active layer can be 10 to 200 micrometers, or 50 to 100 micrometers.

The mixture can comprise 60 to 99 weight percent (wt %), or 50 to 95 wt %, or 70 to 95 wt % of the expanded silicon based on the total weight of the mixture minus any solvent. Likewise, the active layer formed therefrom can comprise 60 to 99 wt %, or 70 to 95 wt % of the expanded silicon based on the total weight of the active layer.

The binder can comprise at least one of a fluoropolymer (for example, at least one of a polytetrafluoroethylene or poly(vinylidene fluoride)), a rubber (for example, an ethylene propylene diene M-class rubber (EPDM) or a styrene-butadiene rubber), a poly(amic acid), a polyimide, a polyamide, a phenolic resin, or an epoxy resin, a cellulose based binder, poly(acrylic acid), a polyacrylonitrile, or an alginate based binder. The mixture can comprise 1 to 40 wt %, or 5 to 30 wt % of the binder based on the total weight of the mixture minus any solvent. Likewise, the active layer formed therefrom can comprise 1 to 40 wt %, or 5 to 30 wt % of the binder based on the total weight of the active layer.

The additive can comprise at least one of an electrically conductive filler, for example, at least one of carbon, copper, nickel, or stainless steel. The electrically conductive filler can comprise a least one of graphite, graphene, carbon fibers, carbon nanotubes, carbon black, or hard carbon. The additive can comprise at least one of tin, manganese oxide, or lithium other than that added from the electrochemical cycling (for example, lithium titanate). The mixture can comprise 1 to 20 wt % or 5 to 10 wt % of the additive based on the total weight of the mixture minus any solvent. Likewise, the active layer formed therefrom can comprise 1 to 20 wt % or 5 to 10 wt % of the additive based on the total weight of the active layer.

The solvent can comprise at least one of N-methyl-pyrrolidone (NMP), acetone, diethyl ether, gamma butyrolactone, isopropanol, dimethyl carbonate, ethyl carbonate, dimethoxyethane, ethanol, or methanol. The mixture can comprise 0 to 70 wt % of the solvent based on the total weight of the mixture.

An electrode can comprise the active layer and a current collector. The current collector can comprise at least one of copper, nickel, stainless steel, or carbon.

The electrode can be used in a battery, for example, using a lithium plate as a counter electrode, the active layer comprising the expanded silicon can be assembled into a lithium ion battery. The electrode can be used as an electrochemical couple. The electrode can be used in a rechargeable or a non-rechargeable battery. The battery can comprise a separator located in between a negative electrode and a positive electrode. When the battery is a lithium ion battery, the separator can be permeable to lithium ions. The ions can be transported in the battery via an electrolyte, for example, as used in the above-described electrochemical cell. A load or a charger can be electrically connected to the negative electrode and the positive electrode via the current collectors in a discharge configuration or a charging configuration, respectively. The negative electrode can comprise the expanded silicon active layer.

The battery can be used in a vehicle, for example, located in the front, middle, or rear of the vehicle. The battery can be coupled to the bottom of the vehicle. When used in a vehicle, the battery can be a lithium-ion battery, for example, for use as a battery for a vehicle with a hybrid drive or a fuel cell vehicle.

The compositions, methods, and articles can alternatively comprise, consist of, or consist essentially of, any appropriate materials, steps, or components herein disclosed. The compositions, methods, and articles can additionally, or alternatively, be formulated so as to be devoid, or substantially free, of any materials (or species), steps, or components, that are otherwise not necessary to the achievement of the function or objectives of the compositions, methods, and articles.

The terms “a” and “an” do not denote a limitation of quantity, but rather denote the presence of at least one of the referenced item. The term “or” means “and/or” unless clearly indicated otherwise by context.

Reference throughout the specification to “a feature”, “an embodiment”, “another embodiment”, “some embodiments”, and so forth, means that a particular element (e.g., feature, structure, step, or characteristic) described in connection with the embodiment is included in at least one embodiment described herein, and may or may not be present in other embodiments. In addition, it is to be understood that the described elements may be combined in any suitable manner in the various embodiments. The endpoints of all ranges directed to the same component or property are inclusive of the endpoints, are independently combinable, and include all intermediate points and ranges. For example, a range of “5 to 20 millimeters” is inclusive of the endpoints and all intermediate values of the ranges of such as 10 to 23 millimeters, etc.). The term “at least one of” means that the list is inclusive of each element individually, as well as combinations of two or more elements of the list, and combinations of at least one element of the list with like elements not named. Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. An expanded silicon electrode, comprising:
a current collector; and
an active layer located on the current collector and in electrical communication with the current collector; wherein the active layer comprises a binder, an expanded silicon, and optionally lithium, wherein the expanded silicon has the formula LiₓSi, where 0≤x≤3.75; and
wherein the active layer expands by less than or equal to 10 volume percent when in use relative to the initial volume of the active layer prior to use.

2. The expanded silicon electrode of claim 1, wherein the expanded silicon has a pore volume of 60 to 90 vol %, or 70 to 80 vol % based on a total volume of the expanded silicon.

3. The expanded silicon electrode of claim 1, wherein the expanded silicon has a BET surface area per unit mass of 10 to 600 m²/g, or 150 to 500 m²/g.

4. The expanded silicon electrode of claim 1, wherein the active layer comprises 60 to 99 wt %, or 70 to 95 wt % of the expanded silicon based on the total weight of the active layer.

5. The expanded silicon electrode of claim 1, wherein the expanded silicon comprises at least one of a carbon coating or an alumina coating.

6. The expanded silicon electrode of claim 1, wherein the binder comprises at least one of a fluoropolymer, a rubber, a poly(amic acid), a polyimide, a polyamide, a phenolic resin, a cellulose based binder, poly(acrylic acid), a polyacrylonitrile, an alginate based binder, or an epoxy resin.

7. The expanded silicon electrode of claim 1, wherein the active layer further comprises at least one of tin, carbon, manganese, iron, zinc, or aluminum.

8. The expanded silicon electrode of claim 1, wherein the electrode is a negative electrode.

9. A battery comprising:
a positive electrode, an expanded silicon negative electrode, and a separator located in between the positive electrode and the expanded silicon negative electrode;
wherein the expanded silicon negative electrode comprises a current collector and an active layer located on at least one side of the current collector and in electrical communication with the current collector;
wherein the active layer comprises a binder, an expanded silicon, and optionally lithium, wherein the expanded silicon has the formula LiₓSi, where 0≤x≤3.75; and
wherein the active layer expands by less than or equal to 10 volume percent when in use relative to the initial volume of the active layer prior to use.

10. The battery of claim 9, wherein the battery is a lithium ion battery.

11. A method of forming an active layer for an electrode comprising:
electrochemically cycling an initial silicon versus lithium from a first voltage to a second voltage at least two times to form an expanded silicon; wherein after the electrochemically cycling, the expanded silicon has the formula LiₓSi, where 0≤x≤3.75;
optionally washing the expanded silicon with an inert solvent;
forming a mixture comprising the expanded silicon, a binder, an optional conductive filler, and an optional solvent; and
forming the active layer from the mixture; wherein the active layer expands by less than or equal to 10 volume percent when in use relative to the initial volume of the active layer prior to use.

12. The method of claim 11, wherein the electrochemically cycling occurs in an electrochemical cell comprising two working electrode current collectors in parallel, a lithium counter electrode; wherein the two working electrode current collectors are positioned such that they maintain electrical communication with the initial silicon and can increase a relative distance there between during electrochemically cycling to form the expanded silicon.

13. The method of claim 12, wherein the electrochemical cell further comprises an electrically conductive, inert particle dispersed in the initial silicon.

14. The method of claim 11, wherein the electrochemically cycling comprises cycling from a high voltage to a low voltage and back to the high voltage two or more times.

15. The method of claim 14, wherein the electrochemically cycling comprises cycling from the high voltage to the low voltage occurs at a constant current; and wherein the electrochemically cycling comprises holding the low voltage for an amount of time to allow the current to drop before cycling back from the low voltage to the high voltage.

16. The method of claim 14, wherein the cycling comprises a final cycle wherein the final voltage reaches allows for an amount of lithium to remain in the expanded silicon such that 0≤x≤3.75.

17. The method of claim 11, wherein the initial silicon comprises greater than or equal to 95 wt % of silicon based on the total weight of the initial silicon.

18. The method of claim 11, further comprising etching at least one of the initial silicon or the expanded silicon to leach out an impurity.

19. The method of claim 11, wherein the mixture further comprises at least one of tin, carbon, manganese, iron, zinc, or aluminum.

20. The method of claim 11, wherein a volume of the expanded silicon is more than 100% of the volume of the initial silicon.
